(19) United States
(12) Patent Application Publication
(10) Pub. No.: US 2025/0229343 A1
(43) Pub. Date: Jul. 17, 2025

(54) DRILL

(71) Applicant: Kennametal Inc., Latrobe, PA (US)

(72) Inventors: Christian Strauchmann, Eggolsheim (DE); Herbert Rudolf Kauper, Rosstal (DE); Jürgen Schwägerl, Vohenstrauss (DE)

(21) Appl. No.: 19/014,975

(22) Filed: Jan. 9, 2025

(30) Foreign Application Priority Data
Jan. 12, 2024 (DE) 1020242003034

(51) Int. Cl. B23B 51/02

(52) U.S. Cl. CPC B23B 51/02; B23B 2231/02

(57) ABSTRACT

The drill extends along an axis of rotation and has a radius (r) as well as a plurality of main cutting surfaces, which each extend in the direction of the axis of rotation from a cutting corner situated on the radius (r), wherein a respective clearance surface adjoins the main cutting surfaces in a circumferential direction (U), forms a clearance angle (α, β1, β2) with respect to a horizontal plane (H) oriented perpendicular to an axis of rotation, and transitions along its further progression into a flute. When viewed in a vertical section parallel to the axis of rotation, an outer section of the clearance surface in the region of the cutting corner has a curved progression, and a near-center section in the region of the axis of rotation has a linear progression. A low frictional load on the front face of the drill is achieved as a result.

### RELATED APPLICATION DATA

The present application claims priority pursuant to 35 U.S.C. § 119 (a) to German Patent Application Number 1020242003034 filed Jan. 12, 2024, which is incorporated herein by reference in its entirety.

### FIELD

The invention relates to a drill, which extends along an axis of rotation and comprises a radius as well as a plurality of main cutting surfaces, which each extend in the direction of the axis of rotation from a cutting corner situated on the radius, whereby a respective clearance surface adjoins the main cutting surfaces in a circumferential direction, forms a clearance angle with respect to a horizontal plane oriented perpendicular to the axis of rotation, and transitions into a flute.

### BACKGROUND

For an advantageous drilling result, the front face at the end of the drills in the region of the main cutting surface are conventionally ground in an appropriate manner using a front-face grinder. The front face is in this case often designed to be tapered and is produced using a tapered-jacket face grinder, or also by a multi-surface grinder. A drill tip having a ground, conical jacket surface can be gathered from US 2014/0308086 A1. What is referred to as a “point” is conventionally formed in the region of the drill center, i.e., in the region of the rotation axis, in order to thin out a drill bit in the region of the frontmost drill tip.

The design of the end geometry of the drill comprising the main cutting surfaces as well as the clearance surfaces significantly affect the drill properties.

Depending on the application and material choice as well as machining parameters, e.g., rotational speed, high stresses also occur during the drilling process, in particular as a result of friction. This also affects chip removal via the flute, whereby a high frictional load occurs, in particular in the subregion of the clearance surfaces adjacent to a respective main cutting surface.

### SUMMARY

Therefore, the object of the invention is to specify a drill which comprises a front geometry and experiences a lower frictional load than conventional drills.

The object according to the invention is achieved by a drill, which extends along an axis of rotation and has a radius as well as a plurality of main cutting surfaces, which each extend from a cutting corner situated on the radius in the direction of the axis of rotation, and thus to a center. The main cutting surfaces adjoin a clearance surface in a circumferential direction, which surface forms a clearance angle with respect to a horizontal plane oriented perpendicular to the axis of rotation. Later along its progression, the clearance surface transitions into a flute in a circumferential direction. When viewed in a vertical section parallel to the axis of rotation and perpendicular to a radial, an outer section of the clearance surface in the region of the cutting corner has a curved progression, whereas a near-center section in the region of the axis of rotation has a linear progression.

In the present context, the term “radius” is understood to mean the nominal radius extending from the axis of rotation in the radial direction as far as the cutting corner.

Seen in a vertical section, the outer section extends along an arcuate line in particular, or is approximated by such an arcuate progression via separate arcuate surface sections.

The progression of the clearance surface, when seen in a vertical section, therefore varies from the axis of rotation in the direction of the cutting corner. Whereas the near-center section of the clearance surface extends in a linear manner, it extends in an arcuate manner in the outer section.

The two sections in this case directly adjoin the main cutting surface in a circumferential direction.

The arcuate progression achieves the particular advantage of the value of the clearance angle changing in a circumferential direction, in particular increasing such that the frictional load is reduced in this region. Due to the radial distance from the axis of rotation, the circumferential velocity in the region of the cutting corner, and thus in the region of the outer section, is greater than in the near-center section. By means of the measure described hereinabove, an effective measure is created for reducing the frictional load in the high-speed range.

The term “near-center section” is preferably understood to mean that this section is designed to be in a radial range greater than 0.1 times or greater than 0.2 times the radius. In addition, the near-center section preferably extends to, e.g., at least 0.5 times the radius. Therefore, the immediate region on the axis of rotation itself, thus in the region of a frontmost drill tip, and in particular also in the region where the point is formed, is preferably not part of the near-center section, in particular because this immediate region on the axis of rotation cannot typically be precisely defined.

In contrast, at least one radially outer region of the outer section having the curved progression is designed to be at a distance of 0.9 times the radius from the axis of rotation.

In the preferred embodiment, the value of the clearance angle in the outer section is greater than the value of the clearance angle in the near-center section. The clearance angle is preferably determined directly adjacent to the main cutting surface. This measure also takes into account the fact that the circumferential velocity in the outer section is higher. Due to the larger clearance angle in this outer section, the friction in the outer section is minimized.

Preferably, the clearance angle in the near-center section having the linear progression has a value in the range of 8° to 10°.

In the outer section of the preferred embodiment, the value of the clearance angle increases in a circumferential direction, specifically from a first value to a second value, due to the curved progression.

The first value is preferably in the range of 10° to 20°.

Furthermore, the second value is preferably in the range of 20° to 40°.

The first value is preferably measured in a circumferential direction at a first angular distance of 5° from the main cutting surface and the second value is measured in a circumferential direction at a 15° angle distance from the main cutting surface.

Overall, a particularly suitable design is achieved by the clearance surface created by the varying clearance angle values, which leads to a low frictional load, and thus a low thermal load, on the drill.

According to a preferred embodiment, the outer section having the curved progression extends continuously into the flute. In other words, the outer section of the clearance surface only follows a curved progression into the flute.

Alternatively, and in particular additionally, the near-center section in the preferred embodiment having the linear progression extends as far as the flute, which adjoins in a circumferential direction. In other words, the clearance surface in the near-center section only extends along a straight line into the flute.

The end of the clearance surface and the beginning of the flute, which adjoins the clearance surface in a circumferential direction, is usually formed by a transition that is, e.g., formed by an edge. For example, a flute is normally oriented below a flute angle that is at least 1.5 times or 2 times greater than the clearance angle of the section of the clearance surface situated directly in front of the flute. The flute angle is defined by the angle at which a flute wall adjacent to the clearance surface in a circumferential direction is oriented relative to the horizontal plane. This flute angle also depends, among other things, on the angle at which the flute is, e.g., oriented at an oblique incline to the axis of rotation. The flute angle is typically in a range greater than 60°.

According to a particularly preferred embodiment, the clearance surface is divided into a circumferential direction by an imaginary, and in particular linear, separation line into a first portion facing the main cutting surface and a second portion facing the flute. The separation line extends from inward to outward and intersects the main cutting surface, at least at an outer intersection. This outer intersection is, e.g., greater than 0.7 times, greater than 0.8 times, and in particular greater than 0.9 times the radius. When viewed in a vertical section, the first portion of the clearance surface extends in a linear manner, and the second portion extends in a curved manner. In this embodiment, the region extending as far as the outer intersection of the clearance surface section adjoining the main cutting surface, which section forms the first portion, therefore defines the near-center section having the linear design. In contrast, the radially outer section outside the intersection defines the outer region having the curved progression.

In the preferred embodiment, the separation line also intersects the main cutting surface at an internal intersection. The latter is in particular in a range of less than 0.2 times and in particular less than 0.1 times the radius.

In this embodiment comprising the two portions of the clearance surface separated by the separation line, the outer region having the curved progression extends continuously from the main edge and into the flute. Preferably, the near-center section in this embodiment having the linear progression additionally adjoins, in a circumferential direction, a clearance surface section having a curved progression.

The line of separation, which divides the first portion that extends in a linear manner and the second portion that extends in a curved manner, preferably extends in a linear direction.

In the preferred embodiment, the line of separation is further oriented parallel to a radial extending through the axis of rotation and through the cutting corner.

### BRIEF DESCRIPTION OF THE DRAWINGS

An exemplary embodiment of the invention is explained in greater detail hereinafter with reference to the drawings. The drawings show the following partially simplified illustrations:

FIG. 1 a sectional side view of a drill,

FIG. 2 an overhead view of a front face at the end of the drill,

FIG. 3 a sectional cross-section view along section line A-A according to FIG. 2,

FIG. 4 a sectional cross-section view along section line B-B according to FIG. 2; and

FIG. 5 a sectional overhead view of the front face at the end of the drill with a line of separation drawn through it, a clearance surface being broken into a first portion and a second portion.

### DETAILED DESCRIPTION

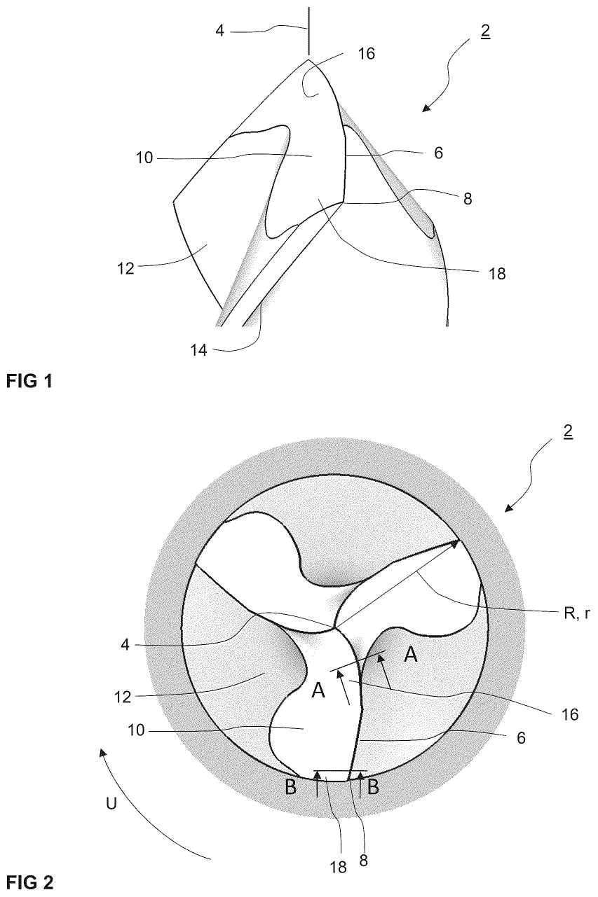

A drill 2, as shown in FIG. 1 and FIG. 2 in a sectional side view and a top view, respectively, is, for example, designed as an integral drill 2. However, the following statements apply equally to, e.g., modular drills in which a drill tip is interchangeably attached to a drill shaft.

The drill 2 generally extends along an axis of rotation 4, about which it rotates during operation. The front face at the end of the drill 2 comprises a plurality of main cutting surfaces 6, each of which extend outward from a central tip located on the axis of rotation 4 as far as a cutting corner 8. The main cutting surfaces 6 extend in a curved manner-when seen from above according to FIG. 2.

Preferably, the main cutting surfaces 6 continue to extend continuously and consistently, thus also in a step-free manner in particular, from the cutting corner 8 as far as the axis of rotation 4. Therefore, the drill 2 is not, e.g., designed as a step drill comprising stepped main cutting surface sections.

A radial distance between the axis of rotation 4 and a respective cutting corner 8 thereby defines a radius r. The connecting line between the axis of rotation 4 and a respective cutting corner 8 defines a radial R. In the exemplary embodiment, the drill 2 comprises a total of three main cutting surfaces 6. Alternatively, the drill only comprises, e.g., two main cutting surfaces 6.

A respective clearance surface 10 adjoins the respective main cutting surface 6 in a circumferential direction U. Along its further progression, this surface transitions into a respective flute 12 in a circumferential direction U. This transition is indicated in the drawings by a curved line and is, e.g., designed as an edge or a rounded transition. Starting from the cutting corner 8, a respective secondary cutting surface 14 extends along the flute 12.

A point can still be formed in the region of the rotational axis 4. The front face of the drill comprising the clearance surfaces 4, the main cutting surfaces 6, and optionally the point is designed as a suitable front-face ground surface.

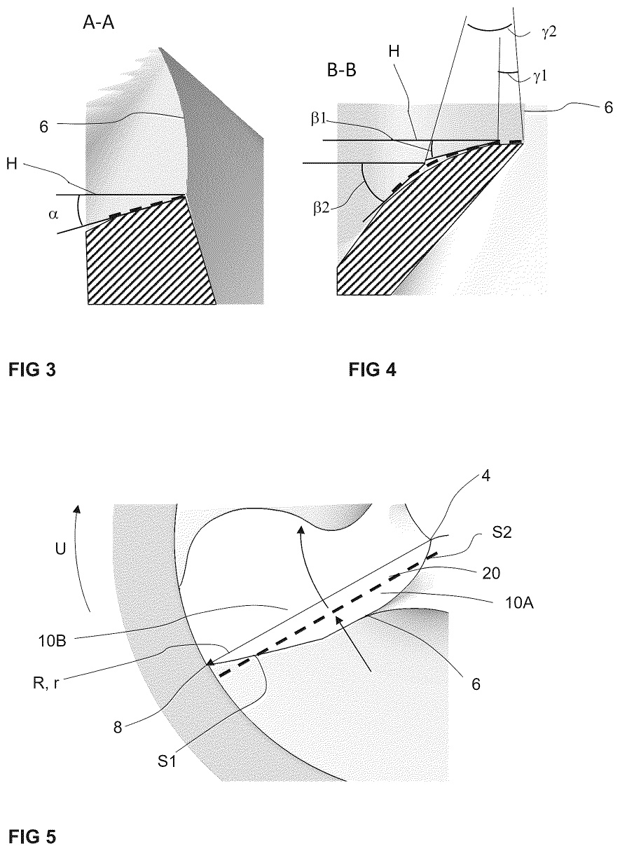

According to the invention, the respective clearance surface 10 features a special profile, as will be explained in greater detail hereinafter in connection with FIGS. 3-5.

Specifically, the clearance surface 10 comprises a section 16 near the center in the region of the axis of rotation 4, as well as an outer section 18 in the region of the cutting corner 8.

When viewed in a vertical section shown in FIG. 3 and FIG. 4, i.e., in a cutting plane parallel to the axis of rotation and perpendicular to the radials, the clearance surface 10 extends in a linear manner in the near-center section 16 and in an arcuate manner in the outer section 18.

With regard to a horizontal plane H that is oriented perpendicular to the axis of rotation 4, the clearance surface 10 in the near-center section 16 is oriented below a constant, near-center clearance angle a, the value of which is preferably in the range of between 8° and 10°.

By contrast, the in particular convex curved progression in the outer section 16 increases an outer clearance angle, specifically from a first outer clearance angle β1 to a second outer clearance angle β2. The first outer clearance angle β1 is preferably in the range between 10°-20°, and the second outer clearance angle β2 is preferably in the range between 20° and 40°.

The first outer clearance angle β1 is measured at a first angular distance γ1 from the main cutting surface 6, which is preferably 5°. The second outer clearance angle 32 is measured at a first angular distance γ2 from the main cutting surface 6, which is preferably 15°.

Due to this measure of increasing the clearance angle in the radial direction on the one hand, i.e., starting from the near-center section 16, then to the outer section 18, and additionally in a circumferential direction U on the outer section 18, the clearance angle is selected in a targeted manner to increase in size in the regions where a circumferential velocity increases during the drilling operation due to the radial distance from the center.

According to a first embodiment, both the near-center section 16 and the outer section 18 extend in a circumferential direction U as far as the beginning of the flute According to a preferred embodiment, as shown by way of example in FIG. 5, the respective clearance surface 10 is divided into a first portion 10A and a second portion 10B. In the first portion 10A, when viewed in the vertical section, the clearance surface 10 extends in a linear manner, as indicated in FIG. 5 by the linear arrow. In the second portion 10B, on the other hand, the clearance surface 10 extends in a curved manner when viewed in a vertical section, as indicated by the curved arrow. The first portion 10A thus forms the near-center section 16. The second portion 10B having the curvilinear progression then respectively adjoins these in a circumferential direction U.

The two portions 10A, 10B are separated from each other by a separator line 20 (indicated by dashes). In the exemplary embodiment, this line extends in a linear manner and parallel to the radials R. The separation line 20 intersects the main cutting surface 6 at an outer intersection S1 and preferably also at an inner intersection S2. The outer intersection S1 is preferably in a range between 0.7 times the radius r and 0.9 times the radius r. The region of the clearance surface 10 adjoining the outer intersection S1 forms the outer section 18 described hereinabove. Also in this embodiment, the latter therefore extends in a continuously curved manner in a circumferential direction U as far as the flute 12.

In contrast, the internal intersection S2 is preferably less than 0.2 times and, in particular, less than 0.1 times the radius r.

1. A drill, which extends along an axis of rotation and has a radius as well as a plurality of main cutting surfaces, which each extend in the direction of the axis of rotation from a cutting corner situated on the radius, wherein a respective clearance surface adjoins the main cutting surfaces in a circumferential direction, forms a clearance angle with respect to a horizontal plane oriented perpendicular to an axis of rotation, and transitions along its further progression into a flute, characterized in that-when viewed in a vertical section parallel to the axis of rotation—an outer section of the clearance surface in the region of the cutting corner has a curved progression, and a near-center section in the region of the axis of rotation has a linear progression.

2. The drill according to claim 1, characterized in that the near-center section having the linear progression is designed to be at least in a range greater than 0.1 times, or greater than 0.2 times, and preferably up to 0.5 times the radius.

3. The drill according to claim 1, characterized in that the outer section having the curved progression is designed to be at least in a range greater than 0.9 times the radius.

4. The drill according to claim 1, characterized in that the value of the clearance angle on the main cutting surface in the outer section is greater than the value of the clearance angle in the near-center section.

5. The drill according to claim 1, characterized in that the clearance angle in the near-center section has a value in the range of 8° to 10°.

6. The drill according to claim 1, characterized in that the clearance angle in the outer section increases from a first value to a second value, starting from the main cutting surface in a circumferential direction.

7. The drill according to claim 6, characterized in that the first value is in the range of 10° to 20°.

8. The drill according to claim 6, characterized in that the second value is in the range of 20° to 40°.

9. The drill according to claim 6, characterized in that the first value in a circumferential direction is measured at a first angular distance of 5° from the main cutting surface, and the second value in a circumferential direction is measured at a second angular distance of 15° from the main cutting surface.

10. The drill according to claim 1, characterized in that the outer section having the curved progression extends into the flute.

11. The drill according to claim 1, characterized in that the near-center section having the linear progression extends into the flute.

12. The drill according to claim 1, characterized in that the clearance surface is divided in a circumferential direction by a separation line into a first portion facing the main cutting surface and into a second portion facing the flute, wherein the separation line extends from inward to outward, and the main cutting surface intersects at least in an outer intersection, wherein, when viewed in a vertical section, the first portion extends in a linear manner and the second portion extends in a curved manner, wherein the outer intersection is preferably situated at greater than 0.7 times, and in particular greater than 0.9 times the radius.

13. The drill according to claim 12, whereby the separation line further intersects the main cutting surface at an internal intersection, which is preferably situated at less than 0.2 times and in particular less than 0.1 times the radius.

14. The drill according to claim 13, in which the separation line is oriented in a linear manner, and in particular parallel to a radial, which extends through the axis of rotation and through the cutting corner.
